(19) United States
(12) Patent Application Publication
(10) Pub. No.: US 2022/0107043 A1
(43) Pub. Date: Apr. 7, 2022

(54) CONNECTOR FOR A HOSE

(71) Applicant: SHIN TAI SPURT WATER OF THE GARDEN TOOLS CO., LTD., CHANG-HUA HSIEN (TW)

(72) Inventor: Chin-Yuan Chen, CHANG-HUA HSIEN (TW)

(21) Appl. No.: 17/061,472

(22) Filed: Oct. 1, 2020

(51) Int. Cl. F16L 33/24

(52) U.S. Cl. CPC F16L 33/24

(57) ABSTRACT

A connector for a hose comprises a first connecting end, a second connecting end and a combining tube. The first connecting end has a main body with a cap shape, a neck portion and an inserting section at a bottom end of the main body, the inserting section has a screw hole connected through the main body and a plurality of engaging protrusions on a circumference of the neck portion. The second connecting end has a threaded section on a circumference thereof, a circular stopping neck internally defining an upper space and a lower space, a plurality of vertical ribs evenly disposed on a sidewall of the lower space, and a plurality of engaging grooves disposed on a top edge of the upper space. The combining tube has a threaded section on a circumference thereof and an enlarged flange at a bottom end.

### BACKGROUND OF INVENTION

### Field of Invention

The present invention relates to a connector for a hose, and more particularly to a connector capable of preventing entanglement of water hoses.

### Description of Related Art

Usually, both ends of the traditional water pipe connector connected between the water pipe and the spray gun cannot be freely rotated, so it is easy to cause the water pipe to twist and wind during use. A water pipe connector with anti-winding function, as shown in FIG. 8 and FIG. 9, includes: a sleeve 60, a connecting pipe 61 and a combining tube 62. The sleeve 60 is formed in a concentric shape with an inner ring 601 and an outer ring 602, and a ring plate 603 is connected between the inner ring 601 and the outer ring 602. The inner surface of the inner ring 601 is provided with an internal threaded hole 604, and the sleeve 60 is provided with a receiving hole 605 connected to the internal threaded hole 604. The outer surface of the outer ring 602 is provided with an outer threaded section 606, and the surface of the ring plate 603 facing the receiving hole 605 is provided with a plurality of the engaging grooves 607. One end of the connecting pipe 61 has an inserting portion 611 at one end and a nut portion 612 at another end. The inserting portion 611 is penetrated with a engaging hole 613, and one end of the inserting portion 611 is projected with a retaining ring 614. The connecting pipe 61 is inserted into the receiving hole 605 of the sleeve 60 with the inserting portion 611, and the stop ring 614 further has at least one protrusion 615 facing the engaging groove 607, so that the protrusion 615 of the connecting pipe 61 is inserted into the engaging groove 607. The combining tube 62 has a through hole 621, convex ring 622 at one end and a threaded section 623 extending from another other end. The combining tube 62 is accommodated in the engaging hole 613 of the connecting tube 61, and the threaded section 623 of the combining tube 62 is locked with the threaded hole 604 of the sleeve 60, so that the convex ring 622 is stopped by the retaining ring 614 of the connecting tube 61 which allows the relative rotation between the connecting tube 61 and the sleeve 60.

However, the above-mentioned previous structure still has the following problems: The engaging groove 607 and the protrusion 615 are completely hidden inside the sleeve 60 and the connecting pipe 61, so the engagement of the protrusion 615 and the engaging groove 607 often requires blind guessing and many attempts, which greatly increases the difficulty of disassembly and assembly of the water pipe connector.

Therefore, it is desirable to provide a connector for a hose to mitigate and/or obviate the aforementioned problems.

### SUMMARY OF INVENTION

An objective of present invention is to provide a connector for a hose, which is capable of improving the above-mention problems.

In order to achieve the above mentioned objective, a connector for a hose comprises a first connecting end, a second connecting end and a combining tube. The first connecting end has a main body with a cap shape, a neck portion and an inserting section at a bottom end of the main body, the inserting section has a screw hole connected through the main body and a plurality of engaging protrusions on a circumference of the neck portion. The second connecting end has a threaded section on a circumference thereof, a circular stopping neck internally defining an upper space and a lower space, a plurality of vertical ribs evenly disposed on a sidewall of the lower space, and a plurality of engaging grooves disposed on a top edge of the upper space. The combining tube has a threaded section on a circumference thereof and an enlarged flange at a bottom end.

Other objects, advantages, and novel features of invention will become more apparent from the following detailed description when taken in conjunction with the accompanying drawings.

### BRIEF DESCRIPTION OF DRAWINGS

FIG. 1 is a three-dimensional drawing of a preferred embodiment according to the present invention.

FIG. 2 is a three-dimensional combined drawing from another angle of the preferred embodiment according to the present invention.

FIG. 3 is a three-dimensional exploded view of the preferred embodiment according to the present invention.

FIG. 4 is a sectional view of the composition of the preferred embodiment according to the present invention.

FIG. 5 is a use state drawing of the preferred embodiment according to the present invention.

FIG. 6 is the anti-winding in-use state drawing of the preferred embodiment according to the present invention.

FIG. 7 is a drawing of the disassembly state of the preferred embodiment after the installation according to the present invention.

FIG. 8 is a three-dimensional combination drawing of the conventional structure.

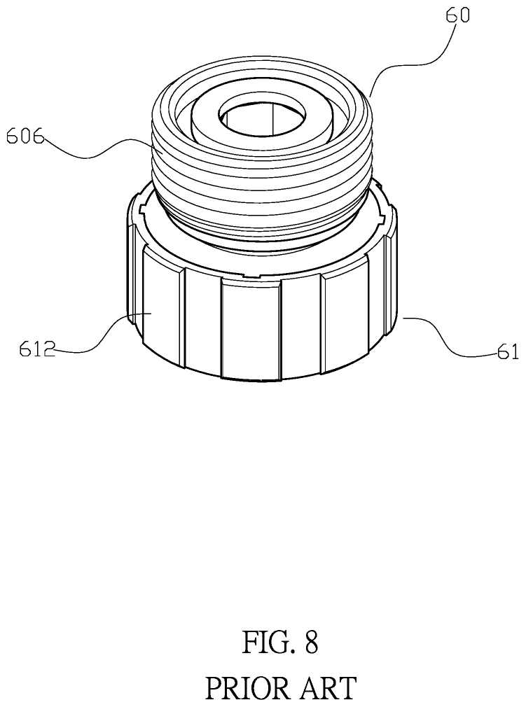

FIG. 9 is a three-dimensional exploded view of the conventional structure.

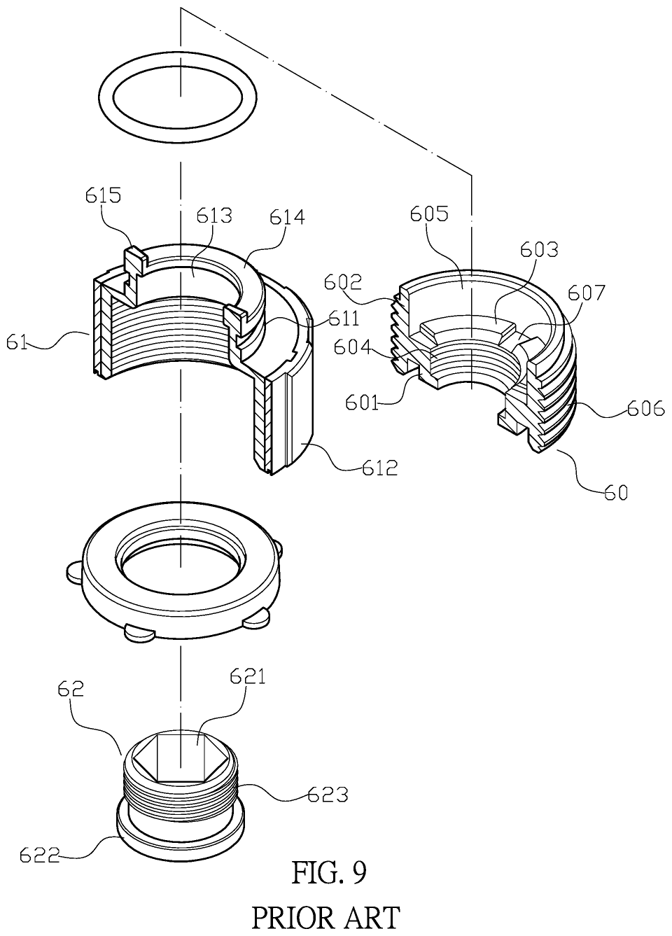

### DETAILED DESCRIPTION OF PREFERRED EMBODIMENT

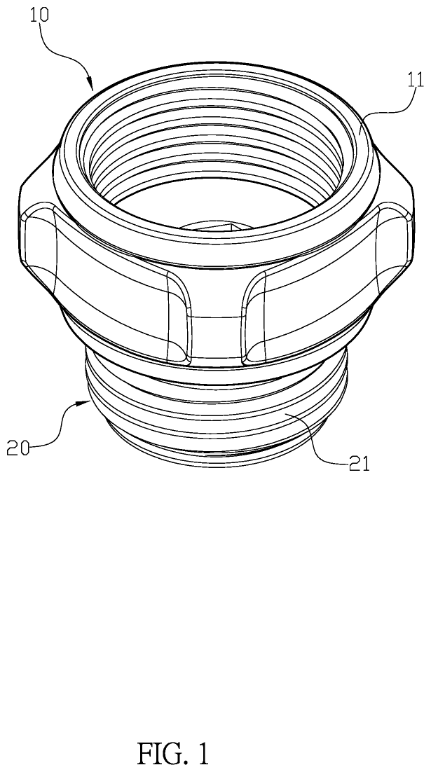

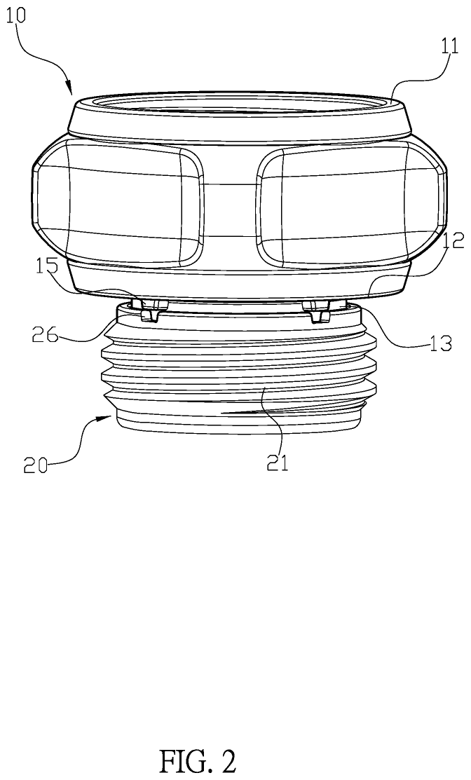

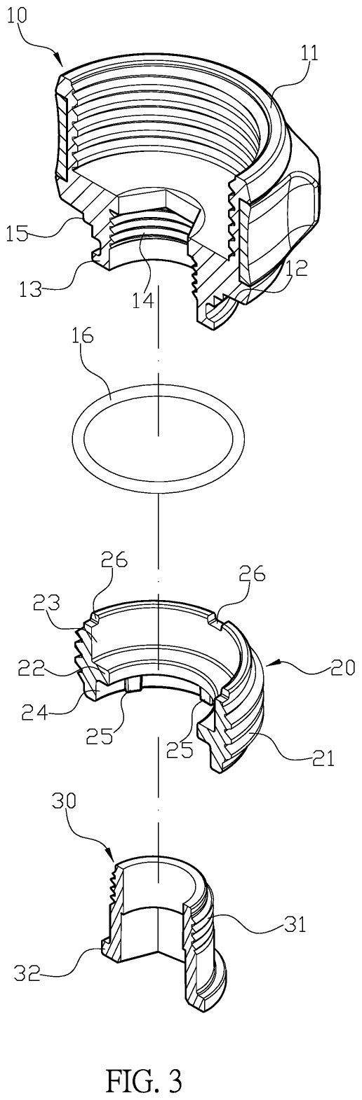

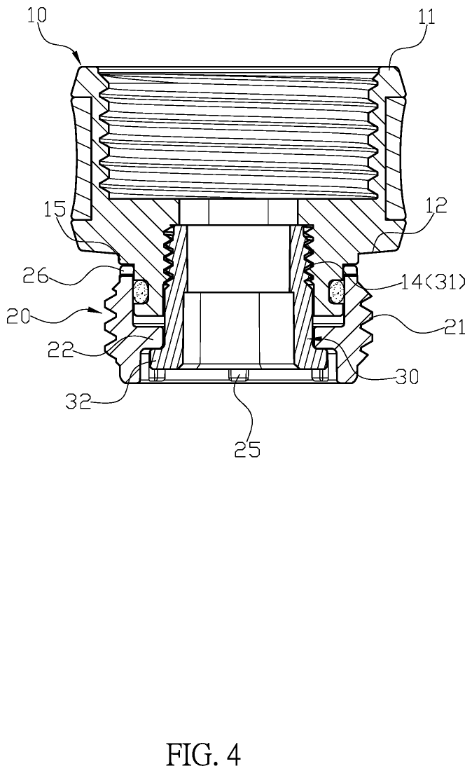

Please refer to FIG. 1-4. A connector for a hose comprises a first connecting end 10, a second connecting end 20 and a combining tube 30. The first connecting end 10 has a main body 11 with a cap shape, a neck portion 12 and an inserting section 13 at a bottom end of the main body 11, the inserting section 13 has a screw hole 14 connected through the main body 11 and a plurality of engaging protrusions 15 on a circumference of the neck portion 12. The second connecting end 20 has a threaded section 21 on a circumference thereof, a circular stopping neck 22 internally defining an upper space 23 and a lower space 24, a plurality of vertical ribs 25 evenly disposed on a sidewall of the lower space 24, and a plurality of engaging grooves 26 disposed on a top edge of the upper space 23. The direct exposure of the engaging grooves 26 and the engaging protrusion 15 provides visual judgment, so that the first connecting end 10 and the second connecting end 20 can be completed more conveniently and quickly. The combining tube 30 has a threaded section 31 on a circumference thereof and an enlarged flange 32 at a bottom end. The combining tube passes through the stopping neck 22 of the second connecting end 20, and the threaded section 31 of the combining tube 30 engages with the screw hole 14 of the first connecting end 10 in the upper space 23. With the mutual restriction of the stopping neck 22 and the flange 32, the combining tube 30 is prevented from directly moving up and detaching from the second connecting end 20, so that the second connecting end 20 can rotate relatively around combination of the first connecting end 10 and the combining tube 30.

Furthermore, the main body 11 of the first connecting end 10 is a hand screw cap

Moreover, the screw hole 14 of the first connecting end 10 has a hexagonal engaging portion for engaging with a hand tool to rotatably drive the first connecting end 10.

In addition, the main body 11 of the first connecting end 10 is a hand screw cap, and the screw hole 14 has a hexagonal engaging portion such that the first connecting end 10 can be rotated manually or by a hand tool.

Also, the inserting section 13 of the first connecting end 10 is sleeved with at least one sealing ring 16

Likewise, the combining tube 30 has a hexagonal engaging portion for engaging with a hand tool to rotate the combining tube 30.

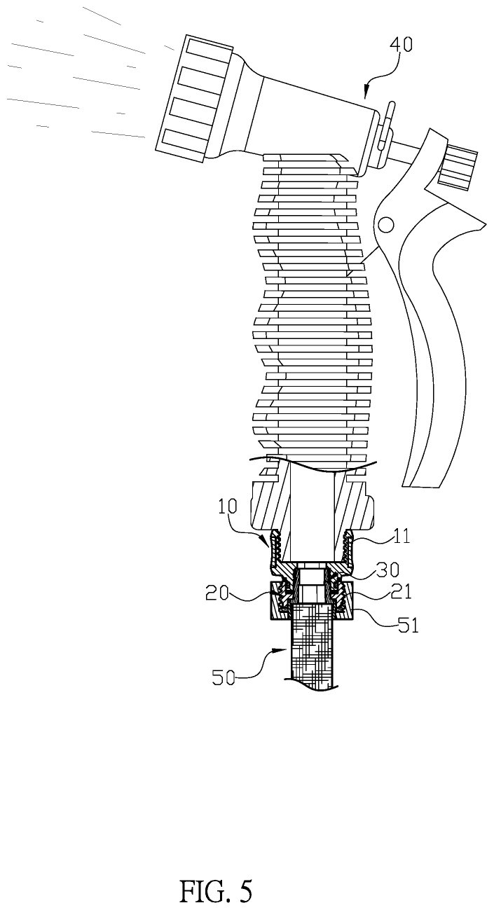

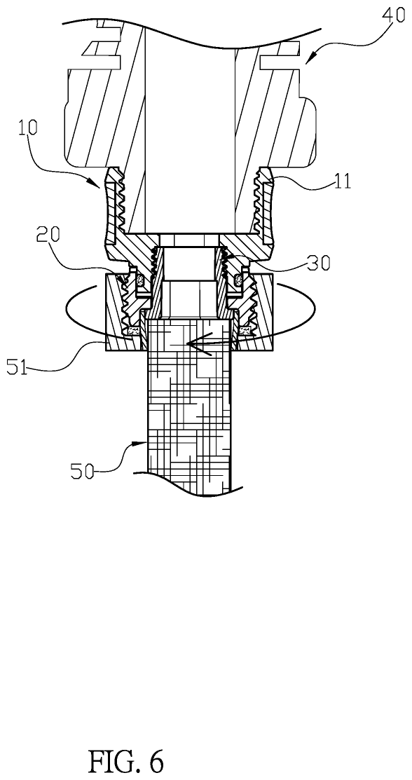

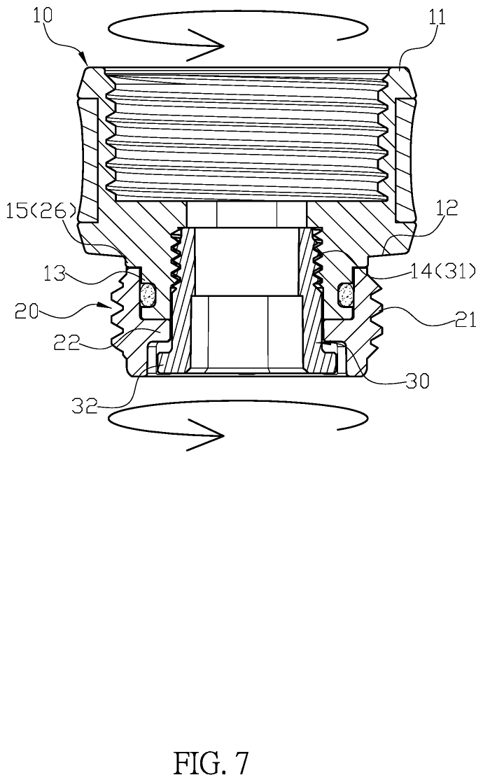

In actual use, the main body 11 of the first connecting end 10 and the threaded section 21 of the second connecting end 20 are respectively attached with a spray gun 40 and a water hose 50, and the second connecting end 20 is completely concealed in a pipe joint 51 of the water hose 50, as shown in FIG. 5, which greatly shorten the exposed length of connector. With the rotatable combination of the first connecting end 10 and the second connecting end 20, as, shown in FIG. 6, the water pipe 50 is free from twisting and winding during the pulling process of the water spray, which greatly improves the convenience of watering operation. Also, please refer to FIG. 7, in order to disassemble the connector, the user holds the main body 11 of the first connecting end 10 and pushes it directly to the second connecting end 20, so that the engaging protrusion 15 of the first connecting end 10 is visually engaging with engaging groove 26 of the second connecting end 20; when the engaging protrusion 15 engages with the engaging groove 26, by rotating the first connecting end 10, the second connecting end 20 can be locked or released so it is easy to disassemble and replace the connector with the water pipe 50.

With the structure of the above specific embodiment, the following benefits can be obtained: The engaging protrusion 15 and the engaging groove 26 are directly exposed foe visual judgment, so the combination of the first connecting end 10 and the second connecting end 20 can be completed quickly one-time without having to make multiple blind attempts. Also, the vertical ribs 25 provide guidance when the combining tube 30 is inserted or moved down by the first connecting end 10, and then the vertical ribs 25 also prevent the flange 32 and the lower space 24 from making a full circle of direct contact, which can effectively reduce the frictional resistance between the two, so that the connector can allow smooth anti-entanglement rotation.

Although the present invention has been explained in relation to its preferred embodiment, it is to be understood that many other possible modifications and variations can be made without departing from the spirit and scope of invention as hereinafter claimed.

What is claimed is:

1. A connector for a hose comprising: a first connecting end, a second connecting end, and a combining tube; wherein:
the first connecting end has a main body with a cap shape, a neck portion and an inserting section at a bottom end of the main body, the inserting section has a screw hole connected through the main body and a plurality of engaging protrusions on a circumference of the neck portion;
the second connecting end has a threaded section on a circumference thereof, a circular stopping neck internally defining an upper space and a lower space, a plurality of vertical ribs evenly disposed on a sidewall of the lower space, and a plurality of engaging grooves disposed on a top edge of the upper space; and
the combining tube has a threaded section on a circumference thereof and an enlarged flange at a bottom end, the combining tube passing through the stopping neck of the second connecting end, and the threaded section of the combining tube engages with the screw hole of the first connecting end in the upper space.

2. The connector for a hose as claimed in claim 1, wherein the main body of the first connecting end is a hand screw cap.

3. The connector for a hose as claimed in claim 1, wherein the screw hole of the first connecting end has a hexagonal engaging portion for engaging with a hand tool to rotatably drive the first connecting end.

4. The connector for a hose as claimed in claim 1, wherein the main body of the first connecting end is a hand screw cap, and the screw hole has a hexagonal engaging portion such that the first connecting end can be rotated manually or by a hand tool.

5. The connector for a hose as claimed in claim 1, wherein the inserting section of the first connecting end is sleeved with at least one sealing ring.

6. The connector for a hose as claimed in claim 1, wherein the combining tube has a hexagonal engaging portion for engaging with a hand tool to rotate the combining tube.
